(19) United States
(12) Patent Application Publication
(10) Pub. No.: US 2017/0233046 A1
(43) Pub. Date: Aug. 17, 2017

(54) COUPLING APPARATUS AND METHOD OF USE TO ENABLE FLUID COMMUNICATION BETWEEN A MULTI-PORT MECHANICAL SWITCH AND A PRIMARY DIVE REGULATOR

(71) Applicants: Gustav A. Ray, Tallahassee, FL (US); Max Mecabe, Tallahassee, FL (US); Raghuram Dhumpa, Tallahassee, FL (US)

(72) Inventors: Gustav A. Ray, Tallahassee, FL (US); Max Mecabe, Tallahassee, FL (US); Raghuram Dhumpa, Tallahassee, FL (US)

(21) Appl. No.: 15/042,546

(22) Filed: Feb. 12, 2016

(51) Int. Cl. B63C 11/18; F16L 25/10

(52) U.S. Cl. CPC B63C 11/186; F16L 25/10

(57) ABSTRACT

The embodiments shown provide a coupling apparatus and method of use to enable fluid communication between a multi-port mechanical switch and a primary dive regulator. The apparatus includes a grooved portion configured to be releasably attached to a multi-port mechanical switch and a leading edge dimensioned to be releasably secured onto a primary dive regulator. The method includes providing the apparatus with the multi-port mechanical switch and primary dive regulator and compressing or extending onto the first end into the multi-port mechanical switch, and extending a second end onto a primary dive regulator to create a hermetically sealed channel for fluid communication through the apparatus.

### FIELD

The embodiments shown herein relate to a coupling apparatus, and in particular, to a coupling apparatus and method of use which enables fluid communication between a multi-port mechanical switch and primary dive regulator.

### BACKGROUND

Today recreational diving has become one of the most popular activities in the United States. One component of these self-contained underwater breathing apparatuses (SCUBA) is a dive regulator, which reduces the pressurized gas contained within a tank to ambient pressure and then delivers it to a user using a second-stage (i.e., primary) dive regulator.

However, different brands of second stage regulators are manufactured in different sizes and configurations. For example, one brand of primary dive regulator may have a more compact design which is configured for users with small jaws. Though these dive regulators may be lighter weight than a larger configuration, they may cause divers to develop jaw fatigue and discomfort. Conversely, a larger configuration may be bulkier and not fit properly within a users jaw causing leaks and carbon-dioxide accumulation.

As more divers travel to popular diving destinations, their ability to carry all of their fitted equipment continues to be challenged by the rising shipping costs, often forcing many divers to rent any available equipment at their final destination. If available, the equipment may vary in size depending on the manufacturers, and leaks may occur while the diver is submerged.

Though there are several references made to conduits to connect fluids, there is not a single reference that provides an apparatus and method of use for providing fluid communication between a multi-port mechanical switch and a primary dive regulator.

### SUMMARY OF THE INVENTION

Embodiments described herein include a dive regulator coupling apparatus and method of use which enables a user to releasably attach both a first end of the apparatus to a multi-port mechanical switch and second end of the apparatus to a primary dive regulator while providing hermetically sealed channel for fluid communication between a multi-port mechanical switch and a varying sized primary dive regulator. Further, the embodiments shown herein include a coupling apparatus having a first and second end dimensioned to be releasably secured to a multi-port mechanical switch and primary dive regulator which enables the user to easily insert the apparatus into the multi-port mechanical switch and onto the primary dive regulator. The coupling apparatus has a substantially elliptical configuration with both an external and internal surface, which when compressed within the multi-port mechanical switch and extended onto the primary dive regulator, creates a male-female coupling in mechanical communication with a plurality of protuberances to provide a fluid passageway to the lungs of a user.

Other aspects, advantages, and novel features of the embodiments shown herein will become apparent from the following detailed description in conjunction with the drawings.

### BRIEF DESCRIPTION OF THE DRAWINGS

A more complete understanding of the embodiments shown, and the attendant advantages and features thereof, will be more readily understood by reference to the following detailed descriptions when considered in conjunction with the accompanying drawings wherein:

FIG. 1 is a perspective view of a coupling apparatus to enable fluid communication between a multi-port mechanical switch and primary dive regulator;

FIG. 2 is a view of the apparatus secured onto the primary dive regulator and aligned to the multi-port mechanical switch;

FIG. 3 is a view of the apparatus secured to the multi-port mechanical switch and the primary dive regulator; and

FIG. 4 is a view of the apparatus secured onto the outward extending aperture of the multi-port mechanical switch.

FIG. 5 is a block diagram illustrating a method of coupling th apparatus to the multi-port mechanical switch and the primary dive regulator.

### DETAILED DESCRIPTION

The specific details of a single embodiment or variety of embodiments described herein are set forth in this application. Any specific details of the embodiments are used for demonstration purposes only, and no unnecessary limitations or inferences are to be understood therefrom.

The embodiments shown relate to a coupling apparatus and method of use to enable fluid communication between a multi-port mechanical switch and a primary dive regulator. Further embodiments shown enable a user to align and compress the first end of the apparatus within or extend onto an outward extending aperture of the multi-port mechanical switch and extend a second end onto a primary dive regulator. Further, the embodiments shown demonstrate a coupling apparatus which enables a plurality of varying sized primary dive regulators to be releasably secured to the multi-port mechanical switch without requiring the user to purchase two different sized multi-port mechanical switches and primary dive regulators.

The apparatus includes a first and second end, an internal and external surface, a grooved portion of the external surface, a leading edge, and first and second protuberance when compressed and extended, are in mechanical communication with the multi-port mechanical switch and the primary dive regulator, creating a hermetically sealed channel to enable fluid communication to the lungs of the user.

The embodiments shown further provide a user the ability to releasably connect a multi-port mechanical switch with a varying size primary dive regulator, protecting the user from the adverse effects of using equipment of varying configurations and dimensions.

A multi-port mechanical switch is an apparatus which enables a user to transition between a first and second breathing chamber (i.e., snorkel and primary dive regulator) using a valve in mechanical communication with an actuator. Specifically, the multi-port mechanical switch enables the user to isolate a desired breathing chamber within the apparatus by depressing the first end of an actuator, configured in a push-button orientation, eliminating the traditional methods that required the user to manipulate air tanks and switch between multiple mouthpieces. An alternate embodiment provide a multi-port mechanical switch that may transition between a first and second breathing chamber using a lever system in mechanical communication with the valve to isolate the respective breathing chambers. The multi-port mechanical switch further includes a housing, valve body, and actuator in mechanical communication with axially slidable valve to transition between a breathing chamber corresponding to a snorkel and a breathing chamber corresponding to a second stage dive regulator (i.e., demand valve).

A primary dive regulator (i.e., second stage regulator) is used in conventional SCUBA diving to reduce the air pressure from an air source, typically in two stages before being received by the user. The primary dive regulator has a plurality of valves in series which function to reduce and deliver the air from the air source to the lungs of the user while protecting the user from over-pressurization. The primary dive regulator typically includes a mouthpiece, diaphragm, air chamber, and a purge valve which utilizes a lever and fulcrum system. Further, the primary dive regulator balances the pressure acting on the outside of the diaphragm with the pressure inside and reduces any “negative pressure accumulation” within the regulator.

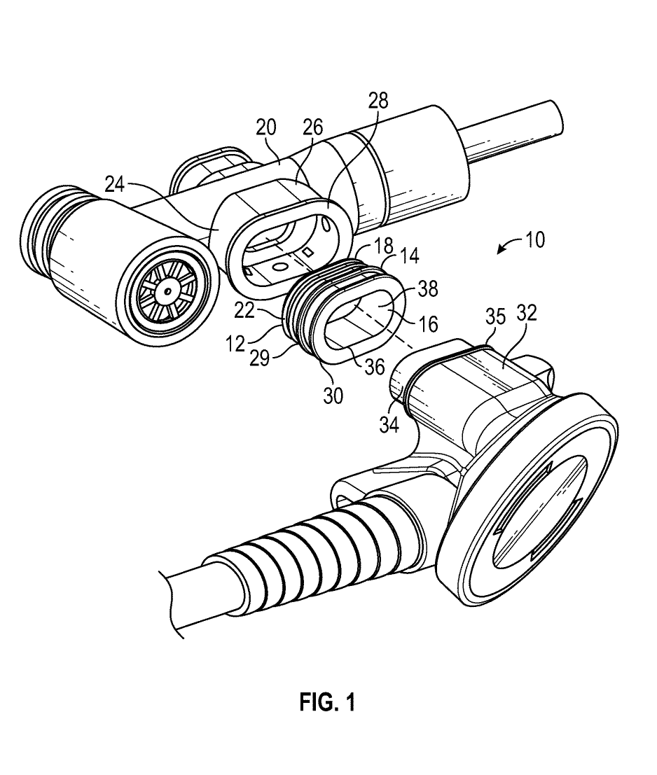

Referring now to the drawings wherein like reference numerals designate identical or corresponding parts throughout the views. There is shown in FIG. 1 a perspective view of a coupling apparatus to enable fluid communication between a multi-port mechanical switch and primary dive regulator 10. The apparatus includes a first end 12 and second end 14; and an internal surface 16 and an external surface 18. Further, the apparatus 10 is composed of a high durometer material and has a length defined by the distance between a first end 12 and a second end 14.

The first end 12 is elliptically configured and dimensioned to be releasably secured within a multi-port mechanical switch 20. The first end 12 further includes a grooved portion of the external surface 22 configured to be releasably received within an outward extending aperture of the multi-port mechanical switch 24. The length of the grooved portion of the external surface 22 is approximately the same length as the distance between a body of the multi-port mechanical switch body 26 and a first end of the outward extending aperture 28. Further, when releasably secured to the outward extending aperture of the multi-port mechanical switch 24, the grooved portion of the external surface 22, comprised of a low durometer material, creates a male-female coupling between a first protuberance 29 and the body of the multi-port mechanical switch 26.

The second end 14 is elliptically configured and further includes a leading edge 30 configured to be releasably secured onto a primary dive regulator 32. Specifically, the second end 14 is dimensioned to be releasably secured to a primary dive regulator receiver 34 creating a hermetic seal between the internal surface 16 and an external surface of the primary dive regulator receiver 34. Further, when the apparatus 10 is extended onto the primary dive regulator receiver 34, a hermetically sealed channel enabling fluid communication between the primary dive regulator 32 and apparatus 10 is created.

The internal surface 16 is elliptically oriented with an overall length measured from the first end 12 to the second end 14, and further includes a first diameter 36, and a second protuberance 38. The first diameter 36 has a substantially uniform diameter that is dimensioned to fit onto the primary dive regulator receiver 34, and when fully extended creates a hermetic seal between leading edge 30 and a primary dive regulator threshold 35. Further, the when the apparatus 10 is fully extended onto the primary dive regulator receiver 34, the second protuberance 38 is in mechanical communication with the external surface of the primary dive regulator 32 and the primary dive regulator threshold 35.

The external surface 18 is elliptically oriented with a constant diameter and an overall length measured from the first end 12 to the second end 14. Further, when the first end 12 is compressed within the multi-port mechanical switch 20, the grooved portion of the external surface 22 expands within the outward extending aperture of the multi-part mechanical switch 24 which prevents the apparatus 10 from inadvertent release while the user is submerged.

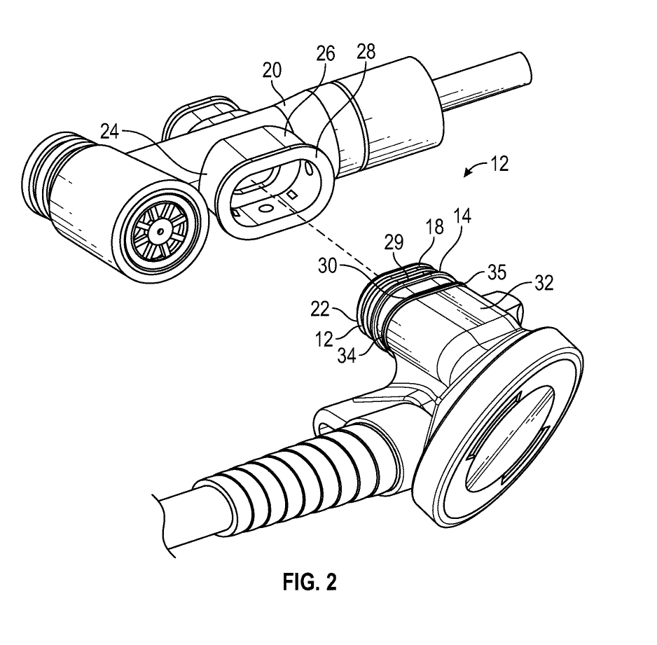

Referring now to FIG. 2, a view of the apparatus 10 releasably secured onto the primary dive regulator 32 and the first end 12 is aligned for compression with the multi-port mechanical switch 20. The apparatus 10 is fully extended onto the primary dive regulator receiver 34 wherein the leading edge 30 is in mechanical communication with the primary dive regulator threshold 35 creating a hermetic seal between a portion of the internal surface 16 and the external surface of the primary dive regulator 32.

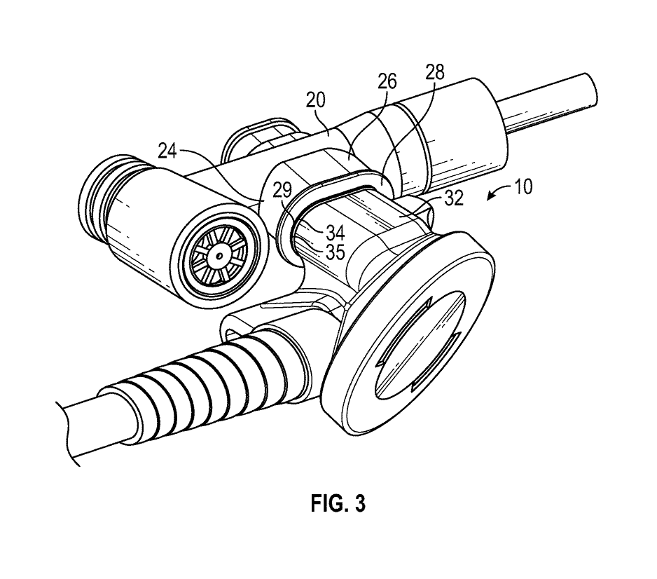

Referring now to FIG. 3, a view of the apparatus 10 compressed within the multi-port mechanical switch 20 at the first end 12 and extended onto the primary dive regulator 32 at the second end 14 creating a sealed channel for fluid communication into the lungs of the user. The first protuberance 29 is in mechanical communication with the first end of the multi-port mechanical switch 28, and the second end 14 and leading edge 30 are in mechanical communication with the primary dive regulator threshold 35.

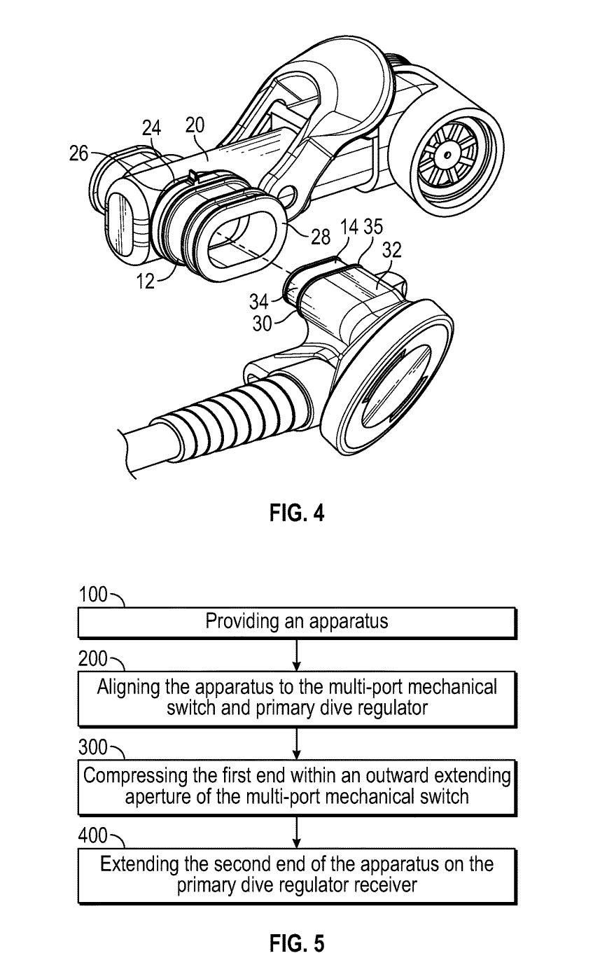

Referring now to FIG. 4, an alternative embodiment illustrating the apparatus extended onto the multi-port mechanical switch 20. Specifically, the first end 12 is releasably secured onto and in mechanical communication with the first end of the multi-port mechanical switch 28. This embodiment further enables a user to provide secondary means of securing the first end 12 onto the multi-port mechanical switch 28 using a securing mechanism such as a cable tie or zip tie. The second end 14 and leading edge 30 are in mechanical communication with the primary dive regulator threshold 35 and may also be further secured using a secondary securing mechanism.

Referring now FIG. 5, a block diagram for coupling apparatus 10 to the multi-port mechanical switch 20 and primary dive regulator 32. The method includes providing an apparatus 10, 100 having a first end 12 and second 14, and an internal surface 16 and external surface 18. The apparatus 10 is then aligned 200 to the outward extending aperture of the multi-port mechanical switch 24 and the primary dive regulator receiver 34. Once aligned, the first end 12 of the apparatus 10 is compressed within the outward extending aperture of the multi-port mechanical switch 24, 300, wherein the low durometer grooved material may expand to create a hermetic male-female coupling between the apparatus 10 and multi-port mechanical switch 20. Once the first end 12 is aligned and compressed within the multi-port mechanical switch 20, the second end is extended onto the primary dive regulator receiver 34, 400 wherein the leading edge 30 is in mechanical communication with the primary dive regulator threshold 35.

Persons skilled in the art will appreciate that the present embodiments go beyond what is particularly shown and described hereinabove. In addition, note that all of the accompanying drawings are not to scale unless otherwise noted. A variety of modifications and variations are possible in light of the above description without departing from the following claims.

What is claimed is:

1. An apparatus to enable fluid communication between a multi-port mechanical switch and a primary dive regulator, the apparatus comprising:
a coupling adapted to enable fluid communication to the lungs of a user through a hermetically sealed channel between a multi-port mechanical switch and at least one varying sized primary dive regulator at a time.

2. The apparatus of claim 1, wherein the coupling apparatus further includes a first end and a second end; the first end dimensioned to be releasably secured to a multi-port mechanical switch, and a second end dimensioned to be releasably secured onto a primary dive regulator.

3. The apparatus of claim 1, wherein the coupling apparatus further includes an internal surface and an external surface; a portion of the internal surface configured to releasably attach onto a primary dive regulator receiver, and a portion of the external surface configured to be releasably secured within an outward extending aperture of the multi-port mechanical switch.

4. The apparatus of claim 1, wherein the first end coupling apparatus is dimensioned to be releasably secured onto the outward extending aperture of the multi-port mechanical switch.

5. The apparatus of claim 1, wherein the first end further includes a grooved portion dimensioned to be releasably secured within the outward extending aperture and to provide a hermetic seal when releasably attached within the outward extending aperture of the multiport mechanical switch.

6. The apparatus of claim 3, wherein the external surface further includes a first protuberance including an internal and external surface further includes a first protuberance and a second protuberance; the first protuberance extending substantially perpendicular from the internal surface to provide mechanical communication with the primary dive regulator while releasably attached, and a second protuberance extending substantially perpendicular from the external surface to provide mechanical communication with the multi-port mechanical switch while engaged.

7. The apparatus of claim 3, wherein the grooved portion of the first end is composed of a high durometer.

8. The apparatus of claim 2, wherein the second end of the coupling apparatus further includes a leading edge configured to be releasably attached onto a receiver of the primary dive regulator and provide a hermetic seal between the apparatus and the primary dive regulator.

9. The apparatus of claim 6, wherein the first end of the coupling apparatus further includes a grooved portion configured to be releasably compressed within an outward extending aperture of the multi-port mechanical switch.

10. The apparatus of claim 6, wherein the second of the coupling apparatus further includes a leading edge configured to be releasably extended onto a receiver of the primary dive regulator.

11. An apparatus to enable fluid communication between a multi-port mechanical switch and a primary dive regulator, the apparatus comprising:
an elongated coupling configured to be mechanically connected to a multi-port mechanical switch at a first end and at least one primary dive regulator of varying size at a second end at a time.

12. The apparatus of claim 12, wherein the first end further includes a grooved portion configured to releasably engage an outward extending aperture of the multi-port mechanical switch.

13. The apparatus of claim 12 wherein the first end is dimensioned to be releasably secured onto an outward extending aperture of the multi-port mechanical switch.

14. The apparatus of claim 12, wherein the second end further includes a leading edge configured to be releasably secured onto a primary dive regulator receiver.

15. The apparatus of claim 12, wherein the apparatus further includes an internal surface dimensioned to be in mechanical communication with an external surface of the primary dive regulator receiver.

16. The apparatus of claim 12, further including a first and a second protuberance while releasably attached with the multi-port mechanical switch and primary dive regulator enable a hermetically sealed channel for fluid communication between the multi-port mechanical switch and the primary dive regulator.

17. A method for attaching a coupling apparatus o a multi-port mechanical switch and a primary dive regulator, the method comprising:
providing an apparatus having a first and second end, and an external and internal surface to provide fluid communication between a varying sized primary dive regulator and a multi-port mechanical switch at a time;
aligning the apparatus to an outward extending aperture of the multi-port mechanical switch and a primary dive regulator receiver;
compressing a first end of the apparatus into the outward extending aperture of the mechanical switch to releasably secure the apparatus within the outward extending apertures to provide a hermetic seal between an external surface of the apparatus and an internal surface of the outward extending aperture; and
extending a second end of the first end of the apparatus onto the primary dive regulator receiver to provide a hermetic seal between an internal surface of the apparatus and an external surface of the primary dive regulator receiver.

18. The method of claim 10, wherein aligning the apparatus further includes inserting a grooved portion of the first end within an outward extending aperture of the multi-port mechanical switch, and the second end onto a primary dive regulator receiver.

19. The method of claim 10, further including a grooved portion configured to enable a user to compress the grooved portion within the outward extending aperture and create a hermetically sealed male-female coupling.

20. The method of claim 10, further including a leading edge configured to enable a user to extend the leading edge onto the primary dive regulator receiver.
